(19) United States
(12) Patent Application Publication
(10) Pub. No.: US 2014/0065335 A1
(43) Pub. Date: Mar. 6, 2014

(54) Luggage Manufactured by Foam Plastic Material

(71) Applicant: Yu-Chi Chen, Changhua City (TW)

(72) Inventor: Yu-Chi Chen, Changhua City (TW)

(21) Appl. No.: 13/597,306

(22) Filed: Aug. 29, 2012

(51) Int. Cl. B32B 1/02; B32B 27/08; B32B 3/26

(52) U.S. Cl. 428/36.5

(57) ABSTRACT

A luggage includes a main body. The main body includes a foamed plastic layer and a thin film layer coated on the foamed plastic layer. Thus, the foamed plastic layer is shockproof, shatterproof, chemical resistant and impact-resistant so that the main body of the luggage is not easily broken or worn out during a long-term utilization. In addition, the foamed plastic layer has a lighter weight so that the main body of the luggage is carried easily and conveniently. Further, the thin film layer is coated on the foamed plastic layer to protect the foamed plastic layer. Further, the thin film layer surrounds the inner surface of the foamed plastic layer and is provided with streaks or patterns so as to enhance the aesthetic quality of the foamed plastic layer.

### BACKGROUND OF THE INVENTION

1. Field of the Invention

The present invention relates to a carrier and, more particularly, to a wheeled luggage or suitcase.

2. Description of the Related Art

A conventional luggage comprises a main body, a handle retractably mounted on the top of the main body, and a plurality of castors mounted on the bottom of the main body. The main body is made of ABS or PC material so that the luggage has a lighter weight. However, the inner side of the main body has a poor appearance so that a lining cloth is mounted in the main body to cover the inner side of the main body, thereby decreasing the aesthetic quality of the main body and increasing the cost of the luggage. In addition, the corners of the main body are weakened during the tensile forming process of the main body so that the corners of the main body are easily broken or worn out during a long-term utilization.

### BRIEF SUMMARY OF THE INVENTION

In accordance with the present invention, there is provided a luggage, comprising a main body. The main body includes a foamed plastic layer and a thin film layer coated on the foamed plastic layer.

Preferably, the foamed plastic layer has a thickness ranged between 4 mm and 15 mm. Preferably, the foamed plastic layer is an EPP foam plastic layer. Alternatively, the foamed plastic layer is an EPO foam plastic layer. Alternatively, the foamed plastic layer is an EPS foam plastic layer. Alternatively, the foamed plastic layer is an EPE foam plastic layer.

Preferably, the thin film layer surrounds an outer surface of the foamed plastic layer. Alternatively, the thin film layer surrounds an outer surface and an inner surface of the foamed plastic layer.

The thin film layer is made of a material that can be combined with the foamed plastic layer. Preferably, the thin film layer is made of PP material. Alternatively, the thin film layer is made of PO material. Alternatively, the thin film layer is made of PS material. Alternatively, the thin film layer is made of PE material. Alternatively, the thin film layer is made of PVC material. Alternatively, the thin film layer is made of PET material.

The primary objective of the present invention is to provide a luggage manufactured by a foam plastic material.

According to the primary advantage of the present invention, the foamed plastic layer is shockproof, shatterproof, chemical resistant and impact-resistant so that the main body of the luggage is not easily broken or worn out during a long-term utilization.

According to another advantage of the present invention, the foamed plastic layer has a lighter weight so that the main body of the luggage is carried easily and conveniently.

According to a further advantage of the present invention, the thin film layer is coated on the foamed plastic layer to protect the foamed plastic layer.

According to a further advantage of the present invention, the thin film layer surrounds the inner surface of the foamed plastic layer and is provided with streaks or patterns so as to enhance the aesthetic quality of the foamed plastic layer.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a luggage in accordance with the preferred embodiment of the present invention.

FIG. 2 is a side cross-sectional view of the luggage as shown in FIG. 1.

FIG. 3 is a partially cross-sectional view of the luggage as shown in FIG. 1.

FIG. 4 is a side cross-sectional view of a luggage in accordance with another preferred embodiment of the present invention.

FIG. 5 is a partially cross-sectional view of the luggage as shown in FIG. 4.

### DETAILED DESCRIPTION OF THE INVENTION

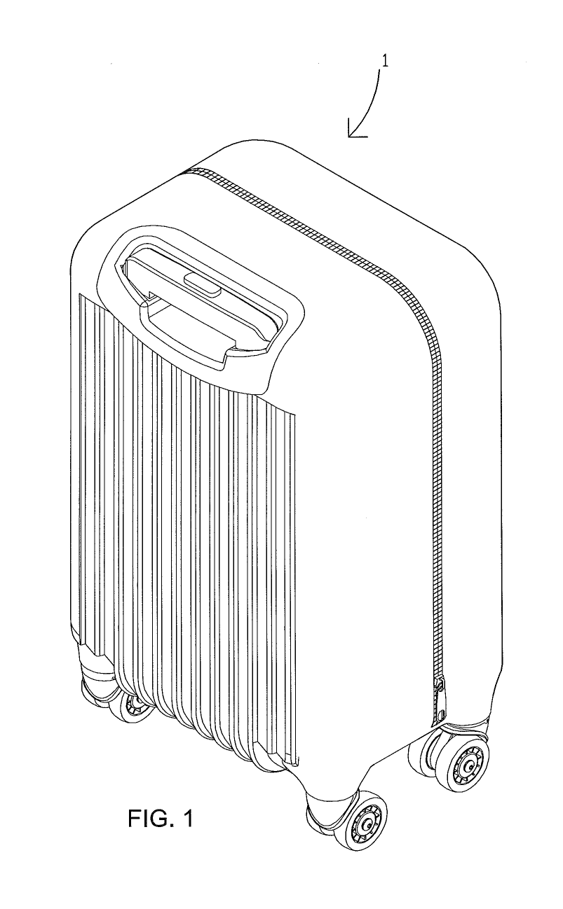

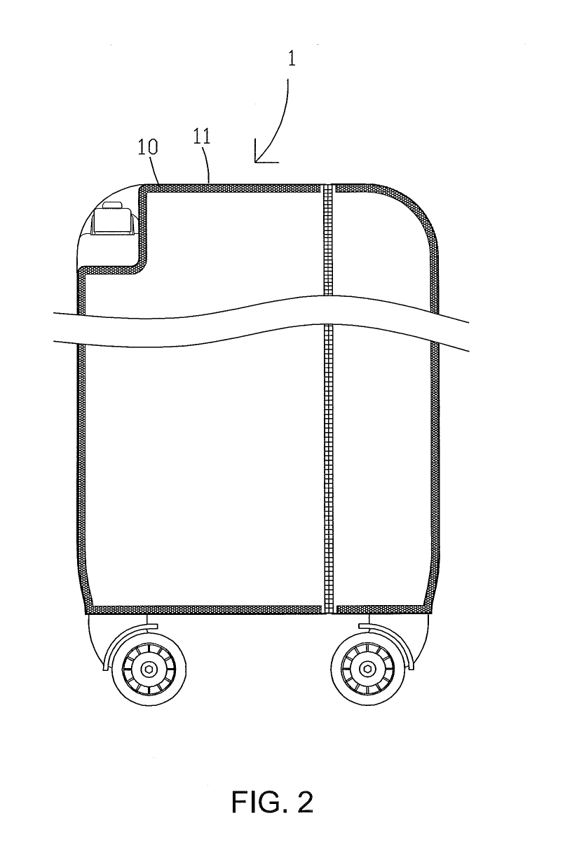

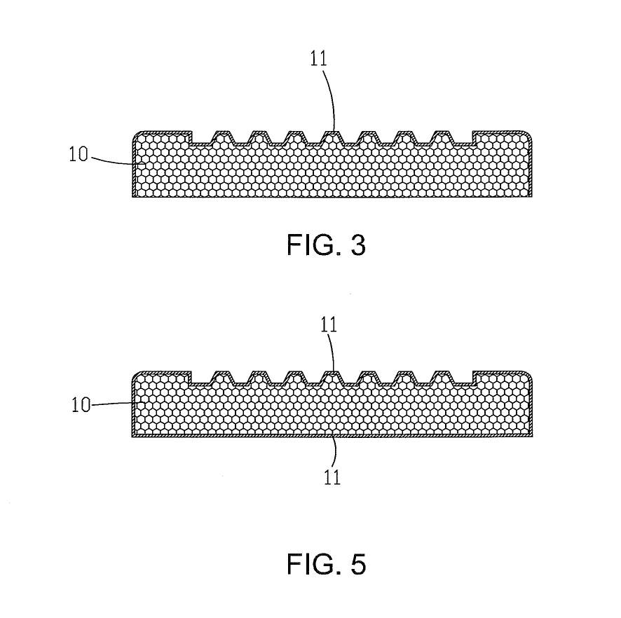

Referring to the drawings and initially to FIGS. 1-3, a luggage in accordance with the preferred embodiment of the present invention comprises a main body 1. The main body 1 includes a foamed plastic layer 10 and a thin film layer 11 coated on the foamed plastic layer 10. Preferably, the thin film layer 11 surrounds an outer surface of the foamed plastic layer 10.

The foamed plastic layer 10 has a thickness that is determined by a practical requirement of the luggage. The thickness of the foamed plastic layer 10 is ranged between 4 mm and 15 mm. In the preferred embodiment of the present invention, the thickness of the foamed plastic layer 10 is optimally ranged between 5 mm and 8 mm.

The foamed plastic layer 10 has a foaming number ranged between 5N and 100N. In the preferred embodiment of the present invention, the foaming number of the foamed plastic layer 10 is optimally ranged between 10N and 50N. In the preferred embodiment of the present invention, the foamed plastic layer 10 is an EPP foam plastic layer which is made of a polypropylene plastic foam material. In such a manner, the foamed plastic layer 10 is shockproof, vibration-proof, impact-resistant, shatterproof, heat resistant, chemical resistant, oil-proof and heatproof. In addition, the foamed plastic layer 10 is resistant to acid and alkali, and has an elastic restoring feature. Further, the foamed plastic layer 10 has a lighter weight to reduce the whole weight of the luggage. Further, the foamed plastic layer 10 has a determined buoyancy. Besides, the EPP foam plastic layer can be reused, recycled and decomposed naturally to prevent from causing an environmental pollution.

In another preferred embodiment of the present invention, the foamed plastic layer 10 is an EPO foam plastic layer which is made of a polyolefin plastic foam material which is mainly a mixture of styrene and polyethylene. In such a manner, the foamed plastic layer 10 has a greater hardness. In addition, the foamed plastic layer 10 is shatterproof and impact-resistant so that the foamed plastic layer 10 is not easily broken into pieces when being subjected to an impact. Further, the foamed plastic layer 10 has a lighter weight to reduce the whole weight of the luggage. Further, the foamed plastic layer 10 has a determined buoyancy.

In another preferred embodiment of the present invention, the foamed plastic layer 10 is an EPS foam plastic layer which is made of a polystyrene (or styrene copolymer) plastic foam material which is a foam mixture of resin, physical foam agent and other additives. In such a manner, the foamed plastic layer 10 has a greater shaping feature with a lower cost of fabrication. In addition, the foamed plastic layer 10 is vibration-proof. Further, the foamed plastic layer 10 has a lighter weight to reduce the whole weight of the luggage. Further, the foamed plastic layer 10 has a determined buoyancy.

In another preferred embodiment of the present invention, the foamed plastic layer 10 is an EPE foam plastic layer which is made of a polyethylene plastic foam material which is a high foam polyethylene product that is formed by pressing and extruding a low density polyethylene. In such a manner, the foamed plastic layer 10 is waterproof, shockproof, soundproof, malleable, recycled and hit-proof In addition, the foamed plastic layer 10 has an environmental protection function. Further, the foamed plastic layer 10 has a greater ductibility. Further, the foamed plastic layer 10 has a lighter weight to reduce the whole weight of the luggage. Further, the foamed plastic layer 10 has a determined buoyancy.

The thin film layer 11 has a surface provided with streaks or patterns whose colors are selected according to the practical requirements. Thus, the thin film layer 11 can be used to protect the foamed plastic layer 10 and has a decorative function. The thin film layer 11 is made of a material that can be combined with the foamed plastic layer 10.

In the preferred embodiment of the present invention, the thin film layer 11 is made of PP material, PO material, PS material, PE material, PVC material, PET material and the like. When the thin film layer 11 is made of PP material, the thin film layer 11 has a flame resistant feature. Thus, when the foamed plastic layer 10 is an EPP foam plastic layer, the thin film layer 11 is a PP thin film layer. Alternatively, when the foamed plastic layer 10 is an EPO foam plastic layer, the thin film layer 11 is a PO thin film layer. Alternatively, when the foamed plastic layer 10 is an EPS foam plastic layer, the thin film layer 11 is a PS thin film layer. Alternatively, when the foamed plastic layer 10 is an EPE foam plastic layer, the thin film layer 11 is a PE thin film layer.

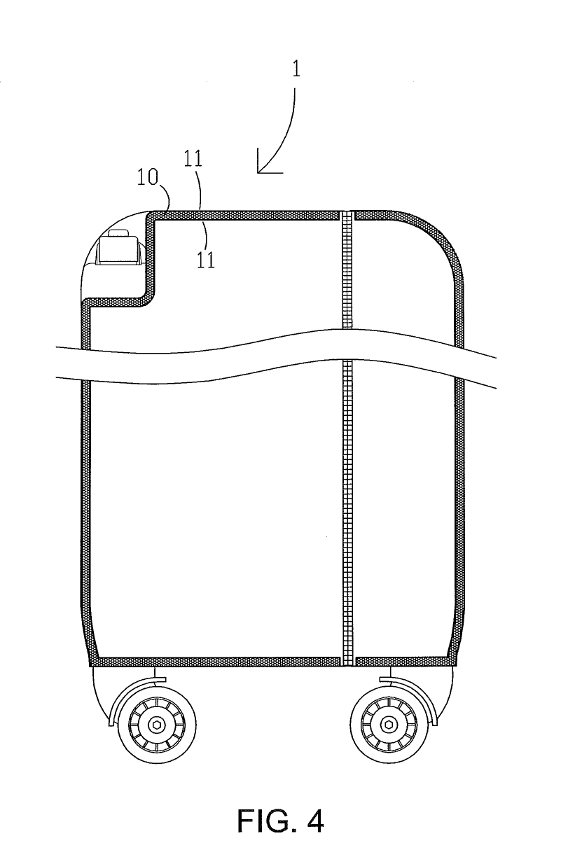

Referring to FIGS. 4 and 5, the thin film layer 11 surrounds an outer surface and an inner surface of the foamed plastic layer 10.

In conclusion, the main body 1 consists of a foamed plastic layer 10 and a thin film layer 11. The thin film layer 11 is coated on the periphery of the foamed plastic layer 10 to protect the foamed plastic layer 10 and to provide a decorative function. In addition, the thin film layer 11 surrounds the inner surface of the foamed plastic layer 10 and is provided with streaks or patterns so as to enhance the aesthetic quality of the foamed plastic layer 10 without having to provide a lining to cover the inner surface of the foamed plastic layer 10. The foamed plastic layer 10 is shatterproof, chemical resistant and impact-resistant so that the main body 1 of the luggage is not easily broken or worn out during a long-term utilization.

Accordingly, the foamed plastic layer 10 is shockproof, shatterproof, chemical resistant and impact-resistant so that the main body 1 of the luggage is not easily broken or worn out during a long-term utilization. In addition, the foamed plastic layer 10 has a lighter weight so that the main body 1 of the luggage is carried easily and conveniently. Further, the thin film layer 11 is coated on the foamed plastic layer 10 to protect the foamed plastic layer 10. Further, the thin film layer 11 surrounds the inner surface of the foamed plastic layer 10 and is provided with streaks or patterns so as to enhance the aesthetic quality of the foamed plastic layer 10.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A luggage, comprising:
a main body. The main body includes a foamed plastic layer and a thin film layer coated on the foamed plastic layer.

2. The luggage of claim 1, wherein the foamed plastic layer has a thickness ranged between 4 mm and 15 mm.

3. The luggage of claim 1, wherein the foamed plastic layer is an EPP foam plastic layer.

4. The luggage of claim 1, wherein the foamed plastic layer is an EPO foam plastic layer.

5. The luggage of claim 1, wherein the foamed plastic layer is an EPS foam plastic layer.

6. The luggage of claim 1, wherein the foamed plastic layer is an EPE foam plastic layer.

7. The luggage of claim 1, wherein the thin film layer surrounds an outer surface of the foamed plastic layer.

8. The luggage of claim 1, wherein the thin film layer surrounds an outer surface and an inner surface of the foamed plastic layer.

9. The luggage of claim 1, wherein the thin film layer is made of PP material.

10. The luggage of claim 1, wherein the thin film layer is made of PO material.

11. The luggage of claim 1, wherein the thin film layer is made of PS material.

12. The luggage of claim 1, wherein the thin film layer is made of PE material.

13. The luggage of claim 1, wherein the thin film layer is made of PVC material.

14. The luggage of claim 1, wherein the thin film layer is made of PET material.

15. The luggage of claim 1, wherein the thin film layer is made of a material that can be combined with the foamed plastic layer.
